(19) United States
(12) Patent Application Publication
(10) Pub. No.: US 2023/0174141 A1
(43) Pub. Date: Jun. 8, 2023

(54) STEERING AXLE FOR A STEERABLE VEHICLE AND INDUSTRIAL TRUCK

(71) Applicant: ZF Friedrichshafen AG, Friedrichshafen (DE)

(72) Inventor: Wolfgang Mauritz, Furstenzell (DE)

(73) Assignee: ZF Friedrichshafen AG, Friedrichshafen (DE)

(21) Appl. No.: 18/061,679

(22) Filed: Dec. 5, 2022

(30) Foreign Application Priority Data
Dec. 7, 2021 (DE) 10 2021 213 862.4

(51) Int. Cl. B62D 5/04; B62D 7/18

(52) U.S. Cl. CPC B62D 5/0418; B62D 5/043; B62D 7/18

(57) ABSTRACT

A steering axle (20) for a steerable vehicle includes an axle housing (1), a first steering knuckle (4), a second steering knuckle (5), a steering motor (6), and a steering gear (16). The first steering knuckle (4) and the second steering knuckle (5) are mounted so as to be steerable in the axle housing (1). The steering axle (20) has a first flexible drive (21) that connects a first output (12) of the steering gear (16) to the first steering knuckle (4) in terms of drive, and a second flexible drive (22) that connects a second output (13) of the steering gear (16) to the second steering knuckle (5) in terms of drive, so that a rotational speed of the steering motor (6) results in a steering movement of the first steering knuckle (4) and of the second steering knuckle (5). Also disclosed is a corresponding industrial truck.

### RELATED APPLICATIONS

This application claims the benefit of and right of priority under 35 U.S.C. § 119 to German Patent Application no. 10 2021 213 862.4, filed on Dec. 7, 2021, the contents of which are incorporated herein by reference in its entirety.

### FIELD OF THE DISCLOSURE

The invention relates to a steering axle for a steerable vehicle and to a corresponding industrial truck.

### BACKGROUND

The prior art discloses various embodiments of power-assisted steering units which either support a manual steering input of a driver or automatically set a desired steering angle in response to an electrical signal. In this case, either a hydraulic cylinder or an electric motor is regularly used as the actuator. Since industrial trucks regularly have to maneuver in a confined space, their steerable wheels can also set comparatively large steering angles.

In this context, DE 10 2019 116 644 A1 discloses a power-assisted steering unit for a vehicle which comprises a steering column having a base and an electrically assisted steering apparatus having a housing and an electric motor.

10 2017 222 887 A1 describes a swing axle for an industrial truck, the steerable wheels of which are driven via a steering drive, which is arranged in the vehicle frame.

10 2017 222 334 A1 discloses an axle arrangement for an industrial truck having two-wheel arrangements, a coupling device and a drive unit for setting steering angles by means of a drive torque. The wheel arrangements are arranged on the coupling device and can be pivoted about a steering axis. A flexible drive is provided for pivoting the wheel arrangements.

### SUMMARY

However, the known steering axles are disadvantageous for various reasons. On the one hand, they require a large amount of space owing to their typically column-like design and, on the other hand, they generally have steering angle errors, which means that the steered wheels are not optimally positioned with respect to one another during cornering and therefore not only roll over the underlying surface but are also pulled or rubbed sideways over the underlying surface relative to their rolling movement. Particularly in the case of large steering angles, the wheels of the known axles increasingly deviate from the “Ackermann angle.” This leads to increased tire wear and to an increased energy requirement.

It is an object of the present invention to propose an improved steering axle for a steerable vehicle.

This object is achieved according to the invention by the steering axle for a steerable vehicle, such as claimed in the independent claims. Further advantageous embodiments and developments of the invention can be found in the dependent claims and the present disclosure.

The invention relates to a steering axle for a steerable vehicle, comprising an axle housing, a first steering knuckle, a second steering knuckle, a steering motor, and a steering gear, wherein the first steering knuckle and the second steering knuckle are mounted so as to be steerable in the axle housing. The steering axle according to the invention is distinguished by the fact that the steering axle further comprises a first flexible drive and a second flexible drive, wherein the first flexible drive connects a first output of the steering gear to the first steering knuckle in terms of drive, and wherein the second flexible drive connects a second output of the steering gear to the second steering knuckle in terms of drive, so that a rotational speed of the steering motor results in a steering movement of the first steering knuckle and of the second steering knuckle.

Thus, a steering axle is provided, i.e. an axle with, in particular, two steerable wheels, which is suitable for use in a vehicle. The vehicle is preferably a commercial vehicle such as an agricultural machine, a work machine, or an industrial truck.

As described, the steering axle first comprises an axle housing, on which all the other components of the steering axle are advantageously arranged. The axle housing thus represents a kind of basic structure of the steering axle. The steering axle is preferably designed as a portal axle. Among other advantages, portal axles often have a comparatively flat axle housing, enabling all the components to be arranged reliably therein or thereon.

Furthermore, the steering axle comprises a steering motor and a steering gear, wherein the steering motor is provided for the actuation of the steerable wheels of the steering axle, in the sense that the steering motor can set a steering angle of the steerable wheels via the steering gear and the flexible drives.

Preferably, the steering motor and the steering gear are arranged at least partially in a common housing.

The steerable wheels can advantageously also be driven wheels, in which case a drive unit is provided, although, in particular, this does not have to be part of the steering axle.

The steering motor is preferably an electric motor, in particular a three-phase, brushless electric motor. As a result, the steering motor has a substantially higher energy efficiency than in the case of design as a hydraulic motor or hydraulic cylinder.

The electric motor is preferably arranged non-rotatably with respect to the axle housing, with the result that its electrical connecting lines are not subjected to any rotation and thus to any mechanical load during each steering movement. However, the steering gear can be rotatable with respect to the electric motor, for example. This is advantageous particularly if the motor torque is comparatively low in relation to the steering torque.

If the steering motor and the steering gear are arranged in a common housing, the common housing can have, for example, a rotary bearing which permits rotation of the housing part assigned to the steering gear relative to the housing part assigned to the steering motor.

In addition, the steering axle comprises the already mentioned first steering knuckle and the already mentioned second steering knuckle, which are both mounted in the axle housing so as to be steerable, i.e. pivotable about the respective steering axis. In this arrangement, a first steerable wheel can be arranged rotatably on the first steering knuckle, and a second steerable wheel can be arranged rotatably on the second steering knuckle. A steering movement of the first steering knuckle can thus be transmitted to the first wheel. Likewise, a steering movement of the second steering knuckle can be transmitted to the second wheel.

According to the invention, it is now envisaged that the steering axle further comprises a first flexible drive and a second flexible drive, wherein the first flexible drive connects a first output of the steering gear to the first steering knuckle in terms of drive, and wherein the second flexible drive connects a second output of the steering gear to the second steering knuckle in terms of drive. A rotational speed of the steering motor thus results in a corresponding steering movement of the first steering knuckle and of the second steering knuckle.

This results in the advantage that—at least to a limited extent—the two steerable steering knuckles or the two steerable wheels are not actuated synchronously with one another, namely in such a way that two orthogonal lines to the axes of rotation of the two steerable wheels always intersect at an intersection point which lies on a straight line congruent with a front axle of the steerable vehicle. Thus, the “Ackermann condition” is advantageously fully satisfied at all times, which in turn means that the wheels do not slide or are not pulled over the ground during cornering but move exclusively in a rolling manner at all times. As a result, in turn, tire wear and the energy requirement during cornering can be significantly reduced.

By using two belt drives in accordance with the invention, it is also advantageously possible to dispense with a comparatively complex steering linkage that takes up space, such as, for example, steering levers and tie rods. The steering axle according to the invention is thus also comparatively compact.

Depending, for example, on the properties or the installation space possibilities of a specific vehicle, the steering motor can furthermore be arranged flexibly at a suitable point between the two steering knuckles, that is to say approximately centrally or else eccentrically and, in particular, also within the axle housing. Since the steering motor is arranged inside the axle housing, the steering axle is of even more compact design.

According to a preferred embodiment of the invention, it is envisaged that the first output is designed as a first drive pulley of the first flexible drive and the second output is designed as a second drive pulley of the second flexible drive, that the first steering knuckle has a first output pulley of the first flexible drive, which is connected to the first steering knuckle for conjoint rotation, and that the second steering knuckle has a second output pulley of the second flexible drive, which is connected to the second steering knuckle for conjoint rotation. Thus, a torque and a rotational speed of the steering motor or of the steering gear can be transmitted to the first steering knuckle in a simple manner by means of the first flexible drive and can be transmitted to the second steering knuckle in an equally simple manner by means of the second flexible drive. For this purpose, the first output and the second output are each designed as a drive pulley with a running surface and, if appropriate, with drivers for the flexible drive, thus advantageously allowing a slip-free drive. The first steering knuckle and the second steering knuckle each correspondingly have an output pulley which, for its part, likewise has a running surface, if appropriate also with drivers for the flexible drive. The first flexible drive thus comprises the first drive pulley, the first output pulley and a first flexible drive means. The second flexible drive correspondingly comprises the second drive pulley, the second output pulley and a second flexible drive means.

According to a further preferred embodiment of the invention, it is envisaged that at least the first drive pulley, the second drive pulley, the first output pulley or the second output pulley have a running surface which deviates from a circular shape, wherein the running surface which deviates from the circular shape is designed in such a way that the first steering knuckle and the second steering knuckle are aligned at an Ackermann angle with respect to one another at each steering angle that can be set and/or wherein at least the first drive pulley, the second drive pulley, the first output pulley or the second output pulley are mounted eccentrically in such a way that the first steering knuckle and the second steering knuckle are aligned at an Ackermann angle with respect to one another at each steering angle that can be set.

For the purposes of the invention, a “running surface which deviates from a circular shape” of the flexible drive is understood to mean a running surface which is not formed by a circular disk or a circular ring but by a geometry which deviates therefrom, for example an oval. Here, the running surface is the face of a disk of this kind over which the flexible drive means runs.

For the purposes of the invention, “eccentric mounting” is understood to mean that the first drive pulley, the second drive pulley, the first output pulley or the second output pulley are arranged at the first or second output or on the first or second steering knuckle in such a way that they do not rotate about their geometric center point during a rotational movement of the first or second output or of the first or second steering knuckle.

Because the running surface of the first and second drive pulleys, for example, deviates from the usual circular shape, there is a non-linear relationship between a rotation of the respective drive pulley and the associated output pulley when a steering angle is set at the first and second wheels. By virtue of the fact that the drive pulleys or output pulleys are of corresponding design to one another, it is thus possible in a simple manner to ensure that the Ackermann condition is always satisfied for each steering angle. The same effect can also be achieved by corresponding eccentric mounting if the first drive pulley, the second drive pulley, the first output pulley or the second output pulley have a circular running surface.

In other words, this means that, in the case of a running surface which deviates from a circular shape, the curvature of the running surface changes continuously. The change in the curvature advantageously has the effect that, on the one hand, the Ackermann condition is satisfied for each steering angle and, on the other hand, in particular also for each steering angle, the flexible drive means remains tensioned to the same extent, with the result that neither sagging of the flexible drive means nor excessive tensioning of the flexible drive means occurs when there is a change in the steering angle. An adjusting means for adjusting the tension of the flexible drive means is thus not absolutely necessary.

According to a particularly preferred embodiment of the invention, it is envisaged that the first drive pulley and the second drive pulley each have elliptical or rectangular running surfaces, wherein edges of the rectangular running surfaces are rounded. In particular, it is preferred that in each case two diagonally opposite edges of a rectangular running surface are rounded to the same extent and differ in their rounding from the other two diagonally opposite edges. Since an ellipse has two different radii and a rectangle has two side surfaces of different lengths, a greater or lesser deflection of one steering knuckle relative to the other steering knuckle can thus be ensured depending on the steering angle, i.e. depending on an orientation of the ellipse or of the rectangle.

According to a further particularly preferred embodiment of the invention, it is envisaged that the first drive pulley has a fixed rotational offset with respect to the second drive pulley. The rotational offset can only be determined if the first drive pulley and the second drive pulley are not circular but, for example, elliptical. The rotational offset then represents the angle by which the respectively longer radii of the two ellipses differ from one another. Since the first drive pulley and the second drive pulley are advantageously rotationally fixed with respect to one another, the rotational offset is correspondingly also fixed.

According to a further particularly preferred embodiment of the invention, it is envisaged that the first output pulley and the second output pulley each have elliptical or rectangular running surfaces, wherein edges of the rectangular running surfaces are rounded. In addition, or as an alternative to the first and second drive pulleys, the first output pulley and the second output pulley can therefore also have elliptical or rectangular running surfaces.

According to a further preferred embodiment of the invention, it is envisaged that the first flexible drive and the second flexible drive are designed as belt drives or as chain drives. A belt drive is comparatively lightweight and inexpensive. Moreover, a belt drive runs quietly. In particular, it is also possible for the belt drive to be designed as a toothed belt drive, thus making it possible to avoid the occurrence of slip. In contrast, a chain drive is comparatively more capable of bearing a load than a belt drive and is suitable for transmitting comparatively higher torques. In the case of a chain drive too, the occurrence of slip can furthermore be reliably avoided.

According to a further preferred embodiment of the invention, it is envisaged that the steering gear is designed as an at least two-stage planetary gear. The at least two planetary stages are arranged between the steering motor and the first and the second output in terms of drive. A motor shaft of the steering motor drives a first planetary stage and an output shaft of the last planetary stage then drives the first and second output. Thus, a comparatively high reduction of the rotational speed can be achieved by means of the at least two planetary stages, which in turn favors the use of a high-speed and thus usually compact electric steering motor.

According to a particularly preferred embodiment of the invention, it is envisaged that the first flexible drive and the second flexible drive are components of the steering gear, in that a running surface of the first drive pulley and a running surface of the second drive pulley are smaller than a running surface of the first output pulley and a running surface of the second output pulley. An additional speed reduction is thus obtained on account of the different sizes of the drive pulleys as compared with the output pulleys. Accordingly, the drive pulleys and the output pulleys are in this case a functional component of the transmission.

According to a further particularly preferred embodiment of the invention, it is envisaged that the first output and the second output are connected for conjoint rotation to a ring gear or a planet carrier of the steering gear. In particular, the first output and the second output are connected for conjoint rotation to an outer side of the ring gear. The ring gear or the planet carrier then preferably represents the output of the steering gear, which is designed, in particular, as an at least two-stage planetary gear. As a particular preference, the ring gear is in this case a common ring gear for all the planetary stages of the steering gear.

According to a further preferred embodiment of the invention, it is envisaged that the steering axle is designed to monitor set steering angles for each individual wheel. It is thus possible to ensure that steering angle errors which occur are detected immediately. In response to a detected steering angle error, it is possible, for example, for a warning to be output, or for the steerable vehicle to be stopped temporarily until repair or maintenance takes place.

The steering angles are preferably monitored by means of electronic sensors.

According to a further preferred embodiment of the invention, it is envisaged that a first adjusting unit is provided, which is designed to automatically adjust a tension of the first flexible drive, and that a second adjusting unit is provided which is designed to automatically adjust a tension of the second flexible drive. Such an adjusting unit can be designed, for example, as a so-called timing chain tensioner, possibly in combination with contact pressure rollers or contact pressure wheels. The adjusting units can either have a return stop, so that a length of the flexible drive means, once adjusted, can no longer be released, or they can be designed without a return stop and can take up or release the respectively required length of the flexible drive means as required. The latter embodiment is particularly suitable for the use of non-circular drive pulleys or output pulleys which require more or less length of the flexible drive means, depending on the rotational position of the drive pulleys or output pulleys. In each case, it is thus possible to ensure that the steering can be controlled precisely and without backlash.

According to a further preferred embodiment of the invention, it is envisaged that the steering motor is arranged in the axle housing or below the axle housing. If the steering motor is arranged below the axle housing and is connected fixedly to the steering gear, the steering gear can, for its part, be connected fixedly to the axle housing, via a flange region for example. Both the arrangement of the steering motor below the axle housing and arrangement in the axle housing save installation space, particularly vertically. In both embodiments, it is preferable if the steering motor cannot rotate relative to the axle housing.

The invention furthermore relates to an industrial truck comprising a steering axle according to the invention. As a result, the advantages already mentioned in connection with the steering axle according to the invention are also obtained for the industrial truck according to the invention.

### BRIEF DESCRIPTION OF THE DRAWINGS

The invention is explained by way of example below with reference to exemplary embodiments illustrated in the figures.

More specifically:

FIG. 1 shows, by way of example, one possible embodiment of a steering axle according to the invention for a steerable vehicle, according to the example for an industrial truck (not illustrated in FIG. 1), in a perspective view,

FIG. 2 shows the steering axle according to FIG. 1 in a view from above,

FIG. 3 shows schematically and in part the steering motor and the steering gear on the axle housing in a common housing, and

FIG. 4 shows schematically another possible embodiment of a steering axle according to the invention for a steerable vehicle in cross section.

Identical objects, functional units and comparable components are denoted by the same reference signs throughout the figures. These objects, functional units and comparable components are of identical design in respect of their technical features, unless explicitly or implicitly implied otherwise by the description.

### DETAILED DESCRIPTION

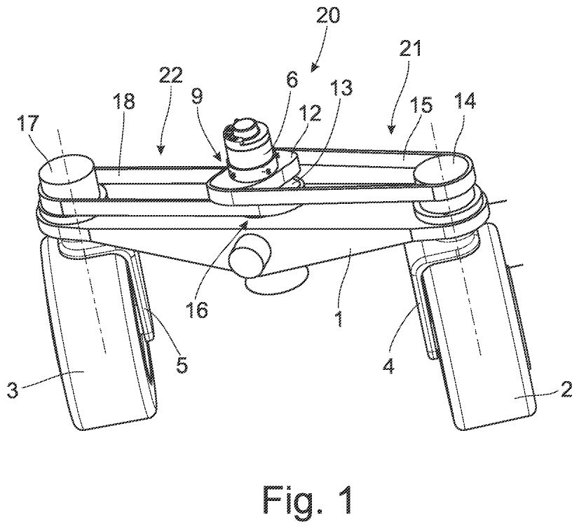

FIG. 1 shows, by way of example, one possible embodiment of a steering axle 20 according to the invention for a steerable vehicle (not illustrated in FIG. 1), according to the example for an industrial truck, in a perspective view. According to the example, the steering axle 20 is designed as a portal axle 20 and comprises an axle housing 1, a steering motor 6, a steering gear 16, a first steering knuckle 4 and a second steering knuckle 5. The first steering knuckle 4 and the second steering knuckle are each mounted so as to be steerable in the axle housing 1. A first steerable wheel 2 is arranged on the first steering knuckle 4 and a second steerable wheel 3 is arranged on the second steering knuckle 5. According to the example, the steering motor 6 and the steering gear 16 are arranged in a common housing 9 on the axle housing 1. The part of the common housing 9 which has the steering gear 16 is rotatably mounted with respect to the part of the common housing 9 which has the steering motor 6. The part of the common housing 9 which has the steering motor 6 cannot rotate relative to the axle housing 1.

According to the example, the steering motor 6 is designed as an electric motor 6 and the steering gear 16 is designed as a two-stage planetary gear 16, in which a ring gear common to both planetary stages forms the output.

The steering axle 20 further comprises a first flexible drive 21 and a second flexible drive 22, wherein the first flexible drive 21 connects a first output 12 of the steering gear 16 to the first steering knuckle 4 in terms of drive, and wherein the second flexible drive 22 connects a second output 13 of the steering gear 16 to the second steering knuckle 5 in terms of drive, so that a rotational speed of the steering motor 6 results in a steering movement of the first steering knuckle 4 and of the second steering knuckle 5.

According to the example, the first flexible drive 21 is embodied as a chain drive 21 and comprises a first drive pulley 12, which is identical with the first output 12. In addition, the first flexible drive 21 comprises a first output pulley 14 and a first chain 15. According to the example, the first output 12 or first drive pulley 12 is connected for conjoint rotation to the ring gear of the planetary gear 16, and the first output pulley 14 is connected for conjoint rotation to the first steering knuckle 4.

According to the example, the second flexible drive 22 is likewise embodied as a chain drive 22 and comprises a first drive pulley 13, which is identical with the second output 13. In addition, the second flexible drive 22 comprises a second output pulley 17 and a second chain 18. The second output 13 or first drive pulley 13 is likewise connected for conjoint rotation to the ring gear of the planetary gear 16, and the second output pulley 17 is connected for conjoint rotation to the second steering knuckle 5.

In this case, the first drive pulley 12 is arranged above the second drive pulley 13.

As can be seen, the first drive pulley 12 and the second drive pulley 13 have a substantially rectangular shape with rounded corners, wherein on each drive pulley 12, 13 two diagonally opposite edges are rounded to a greater or lesser extent than the two other diagonally opposite edges. The running surface for the first chain 15 or the second chain 18 follows this rectangular shape with rounded edges. This results in a non-linear relationship between a rotation of the respective drive pulley 12, 13 and the associated output pulley 14, 17. By virtue of this different actuation of the first steering knuckle 4 and of the second steering knuckle 5, it is possible in a simple manner to ensure that the Ackermann condition is always satisfied for each steering angle. This results in reduced tire wear as well as a reduced energy requirement when cornering.

As can furthermore be seen, the first drive pulley 12 has a fixed rotational offset with respect to the second drive pulley 13. Like the geometric deviation of the first drive pulley 12 and the geometric deviation of the second drive pulley 13 from the circular shape, the rotational offset angle contributes to satisfying the Ackermann condition at each steering angle. By means of the selection of the rotational offset and the precise geometric design of the running surfaces of the first drive pulley 12 and of the second drive pulley 13 from the circular shape, the Ackermann condition can be set in each case for different track widths and wheelbases.

According to the example, the first output pulley 14 and the second output pulley 17, on the other hand, have a circular running surface.

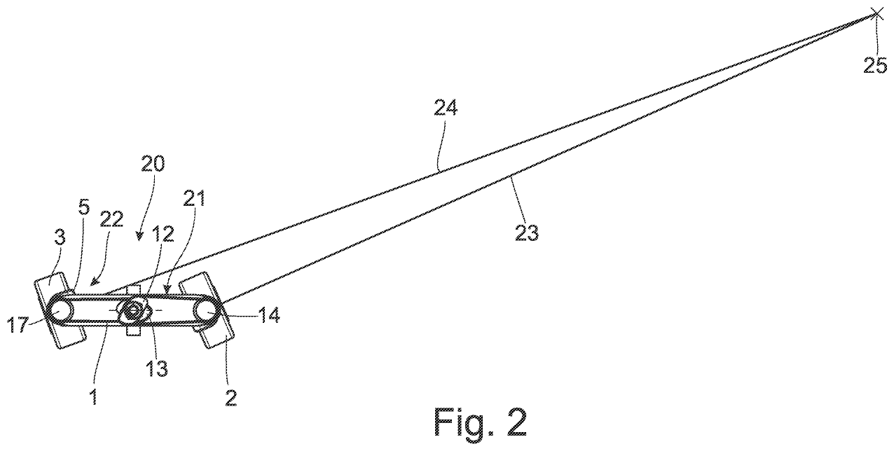

FIG. 2 shows the steering axle 20 according to FIG. 1 in a view from above. As can be seen, the steerable wheels 2, 3 of the steering axle 20 are turned. In order to avoid slipping of the wheels 2, 3 during cornering, the wheels 2, 3 have the so-called Ackermann angle with respect to one another, i.e. two orthogonal lines 23, 24 to the axes of rotation of the steerable wheels 2, 3 always intersect at an intersection point 25 which lies on a straight line congruent with a front axle (not illustrated) of the steerable vehicle. Since the Ackermann condition is thus completely satisfied, the wheels 2, 3 can move exclusively in a rolling manner at any time. As a result, in turn, tire wear and the energy requirement during cornering are significantly reduced.

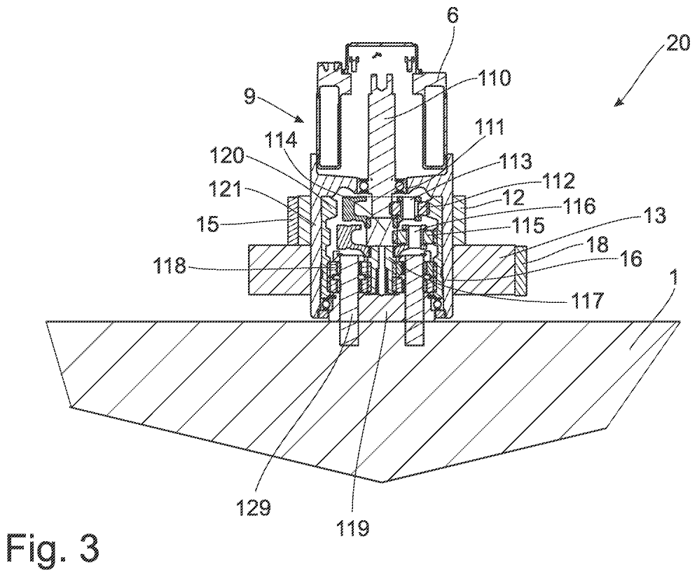

FIG. 3 shows schematically and in part the steering motor 6 and the steering gear 16 on the axle housing 1 in a common housing 9. A motor shaft 110 of the steering motor 6 embodied as an electric motor 6 drives a first sun wheel 111, which meshes with first planet wheels 112. These, in turn, drive the first planet carrier 113, which is connected for conjoint rotation to a second sun wheel 114. The second sun wheel 114 meshes with second planet wheels 115, which drive a second planet carrier 116. The latter is connected for conjoint rotation to a third sun wheel 117, the third sun wheel 117 meshing with third planet wheels 118. The third planet wheels 118 drive the third planet carrier 119, which is connected for conjoint rotation to the axle bridge 1. According to the example, it is screwed to the axle housing 1. All the planet wheels 112, 115, 118 mesh with the ring gear 120, with the result that the latter rotates about its own axis. The ring gear 120 is connected for conjoint rotation to the ring gear carrier 121, on which, in turn, the two drive wheels 12, 13 are arranged for conjoint rotation. As an example, the round planet carrier pins 129 engage directly into the axle housing 1 and thus ensure low-cost and reliable alignment and rotation prevention of the third planet carrier 119 and of the third planet wheels 118 relative to the axle housing 1.

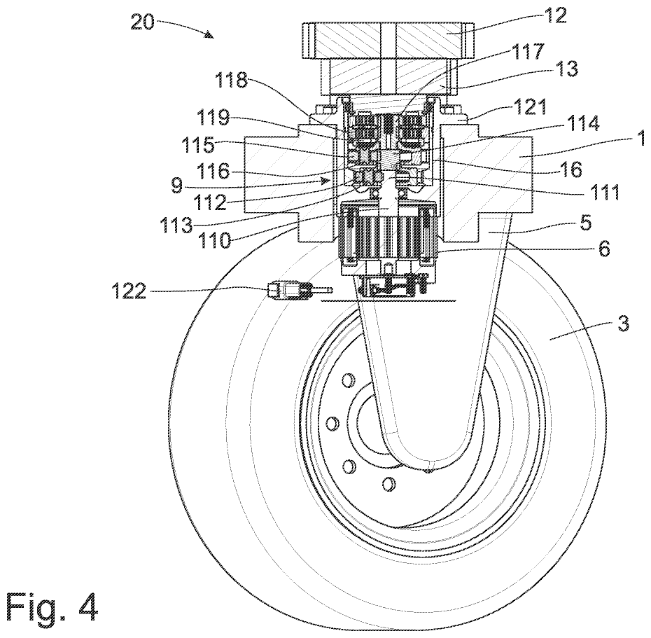

FIG. 4 shows schematically another possible embodiment of a steering axle 20 according to the invention for a steerable vehicle in cross section. As can be seen, according to the embodiment of FIG. 4, the steering motor 6 is arranged below the axle housing 1, and the steering gear 16 is arranged inside the axle housing 1. In this case, the ring gear carrier 121 is connected to the axle housing 1 for conjoint rotation via a flange region, and the first drive pulley 12 and the second drive pulley 13 are firmly screwed to the third planet carrier 119. The steering motor 6 is thus connected for conjoint rotation to the axle housing 1. The overall height of the steering axle 20 is thereby kept low.

It can furthermore be seen that an electronic steering angle sensor 122 detects a set steering angle without contact.

### REFERENCE SIGNS

1 axle housing
2 first wheel
3 second wheel
4 first steering knuckle
5 second steering knuckle
6 steering motor
9 common housing
12 first drive pulley
13 second drive pulley
14 first output pulley
15 first flexible drive means, first chain
16 steering gear, planetary gear
17 second output pulley
20 steering axle, portal axle
21 first flexible drive, first chain drive
22 second flexible drive, second chain drive
23 orthogonal line
24 orthogonal line
25 intersection point
110 motor shaft
111 first sun wheel
112 first planet wheels
113 first planet carrier
114 second sun wheel
115 second planet wheels
116 second planet carrier
117 third sun wheel
118 third planet wheels
119 third planet carrier
120 ring gear
121 ring gear carrier
122 electronic steering angle sensor
129 planet carrier pins

1. A steering axle (20) for a steerable vehicle, comprising:
an axle housing (1);
a first steering knuckle (4);
a second steering knuckle (5);
a steering motor (6);
a steering gear (16) having a first output and a second output, wherein the first steering knuckle (4) and the second steering knuckle (5) are mounted so as to be steerable in the axle housing (1); and
a first flexible drive (21) and a second flexible drive (22), wherein the first flexible drive (21) connects the first output (12) of the steering gear (16) to the first steering knuckle (4) in terms of drive, and wherein the second flexible drive (22) connects the second output (13) of the steering gear (16) to the second steering knuckle (5) in terms of drive, so that a rotational speed of the steering motor (6) results in a steering movement of the first steering knuckle (4) and of the second steering knuckle (5).

2. The steering axle (20) as claimed in claim 1, wherein the first output (12) is configured as a first drive pulley (12) of the first flexible drive (21) and the second output (13) is configured as a second drive pulley (3) of the second flexible drive (22), wherein the first steering knuckle (4) has a first output pulley (14) of the first flexible drive (21), which is connected to the first steering knuckle (4) for conjoint rotation, and wherein the second steering knuckle (5) has a second output pulley (17) of the second flexible drive (22), which is connected to the second steering knuckle (5) for conjoint rotation.

3. The steering axle (20) as claimed in claim 1, wherein at least one of the first drive pulley (12), the second drive pulley (13), the first output pulley (14) or the second output pulley (17) have a running surface which deviates from a circular shape;
wherein the running surface which deviates from the circular shape is configured so that the first steering knuckle (4) is aligned at an Ackerman angle with respect to the second steering knuckle (5) at each steering angle that can be set and/or wherein at least one of the first drive pulley (12), the second drive pulley (13), the first output pulley (14) or the second output pulley (17) are mounted eccentrically in such a way that the first steering knuckle (4) is aligned at an Ackerman angle with respect to the second steering knuckle (5) at each steering angle that can be set.

4. The steering axle (20) as claimed in claim 3, wherein the first drive pulley (12) and the second drive pulley (13) each has an elliptical running surface or a rectangular running surface with rounded edges.

5. The steering axle (20) as claimed in claim 4, wherein the first drive pulley (12) has a fixed rotational offset with respect to the second drive pulley (13).

6. The steering axle (20) as claimed in claim 5, wherein the first output pulley (14) and the second output pulley (17) each has an elliptical running surface or a rectangular running surface with rounded edges.

7. The steering axle (20) as claimed in claim 1, wherein the first flexible drive (21) and the second flexible drive (22) are designed as belt drives or as chain drives.

8. The steering axle (20) as claimed in claim 1, wherein the steering gear (16) is configured as an at least two-stage planetary gear (16).

9. The steering axle (20) as claimed in claim 8, wherein the first flexible drive (21) and the second flexible drive (22) are components of the steering gear (16), in that a running surface of the first drive pulley (12) and a running surface of the second drive pulley (13) are smaller than a running surface of the first output pulley (14) and a running surface of the second output pulley (17).

10. The steering axle (20) as claimed in claim 9, wherein the first output (12) and the second output (13) are connected for conjoint rotation to a ring gear (120) or a planet carrier (119) of the steering gear (16).

11. The steering axle (20) as claimed in claim 1, wherein the steering axle (20) is configured to monitor set steering angles for each individual wheel of the steerable vehicle.

12. The steering axle (20) as claimed in claim 1, wherein a first adjusting unit is provided, the first adjusting unit configured to automatically adjust a tension of the first flexible drive (21), and wherein a second adjusting unit is provided, the second adjusting unit configured to automatically adjust a tension of the second flexible drive (22).

13. The steering axle (20) as claimed in claim 1, wherein the steering motor (6) is configured as an electric motor (6).

14. The steering axle (20) as claimed in claim 1, wherein the steering axle (20) is configured as a portal axle (20).

15. The steering axle (20) as claimed in claim 1, wherein the steering motor (6) is arranged in the axle housing (1) or below the axle housing (1).

16. An industrial truck, comprising a steering axle (20) as claimed in claim 1.

17. A steering axle (20) for a steerable vehicle, comprising:
an axle housing (1);
a first steering knuckle (4);
a second steering knuckle (5);
a steering motor (6);
a steering gear (16) having a first output and a second output, wherein the first steering knuckle (4) and the second steering knuckle (5) are mounted so as to be steerable in the axle housing (1); and
a first flexible drive (21) and a second flexible drive (22), wherein the first flexible drive (21) connects the first output (12) of the steering gear (16) to the first steering knuckle (4) in terms of drive, and wherein the second flexible drive (22) connects the second output (13) of the steering gear (16) to the second steering knuckle (5) in terms of drive, so that a rotational speed of the steering motor (6) results in a steering movement of the first steering knuckle (4) and of the second steering knuckle (5);
wherein the first drive pulley (12) and the second drive pulley (13) each has an elliptical running surface or a rectangular running surface with rounded edges, and wherein the first flexible drive (21) and the second flexible drive (22) are designed as belt drives or as chain drives.

18. The steering axle (20) as claimed in claim 17, further comprising:
a first adjusting unit configured to automatically adjust a tension of the first flexible drive (21); and
a second adjusting unit configured to automatically adjust a tension of the second flexible drive (22).

19. The steering axle (20) as claimed in claim 18, wherein the steering motor (6) is configured as an electric motor (6) and wherein the steering axle (20) is configured as a portal axle (20).

20. The steering axle (20) as claimed in claim 19, wherein the steering motor (6) is arranged in the axle housing (1) or below the axle housing (1).
